(19) United States
(12) Patent Application Publication
(10) Pub. No.: US 2026/0095973 A1
(43) Pub. Date: Apr. 2, 2026

(54) TECHNIQUES FOR REDUCING LATENCY IN TRANSMITTING PAGING SIGNALS IN WIRELESS COMMUNICATIONS

(71) Applicant: QUALCOMM Incorporated, San Diego, CA (US)

(72) Inventors: Ahmed BEDEWY, Hillsborough, NJ (US); Navid Abedini, Basking Ridge, NJ (US); Junyi Li, Greentown, PA (US); Tao Luo, San Diego, CA (US)

(21) Appl. No.: 18/903,477

(22) Filed: Oct. 1, 2024

(51) Int. Cl. H04W 76/28; H04W 52/02; H04W 68/02

(52) U.S. Cl. CPC H04W 76/28; H04W 52/0235; H04W 68/025

(57) ABSTRACT

Aspects described herein relate to receiving a control information having a field indicating that the control information is for one of multiple events associated with control or triggering without data allocation, obtaining, from the control information and based on the field, an event identifier from an event identifier field indicating a type of control or triggering event associated with the control information, and performing, based on the event identifier, the control or triggering associated with the control information. Other aspects relate to generating and transmitting the control information.

### FIELD OF THE DISCLOSURE

Aspects of the present disclosure relate generally to wireless communication systems, and more particularly, to transmitting paging signals.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to receive, from a network node, an indication of whether paging messages in at least one of multiple paging occasions of a discontinuous receive (DRX) cycle are broadcasted in all of a set of multiple beams or in a portion of the set of multiple beams that does not include all beams in the set of multiple beams, and receive, based on the indication, one or more paging messages in the at least one of multiple paging occasions of the DRX cycle.

In another aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to transmit, using a subset of configured beams, one or more first paging messages in a first paging occasion of multiple paging occasions of a DRX cycle, and transmit, for a UE having a paging priority that achieves a threshold, and using at least one of the subset of configured beams that is associated with the UE, one or more second paging messages in a second paging occasion of the multiple paging occasions of the DRX cycle.

In another aspect, a method for wireless communication at a UE is provided that includes receiving, from a network node, an indication of whether paging messages in at least one of multiple paging occasions of a DRX cycle are broadcasted in all of a set of multiple beams or in a portion of the set of multiple beams that does not include all beams in the set of multiple beams, and receiving, based on the indication, one or more paging messages in the at least one of multiple paging occasions of the DRX cycle.

In another aspect, a method for wireless communication at a network node is provided that includes transmitting, using a subset of configured beams, one or more first paging messages in a first paging occasion of multiple paging occasions of a DRX cycle, and transmitting, for a UE having a paging priority that achieves a threshold, and using at least one of the subset of configured beams that is associated with the UE, one or more second paging messages in a second paging occasion of the multiple paging occasions of the DRX cycle.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 is a flow chart illustrating an example of a method for transmitting paging messages in multiple paging occasions (POs), in accordance with aspects described herein;

FIG. 6 is a flow chart illustrating an example of a method for receiving and/or processing paging messages in one or multiple POs, in accordance with aspects described herein;

FIG. 7 illustrates an example of a timeline having multiple discontinuous reception (DRX) cycles each with two POs using paging spatial adaptation, in accordance with aspects described herein;

FIG. 8 illustrates an example of a timeline having multiple DRX cycles each with two POs using paging spatial adaptation with priority paging, in accordance with aspects described herein;

FIG. 9 illustrates an example of a timeline having multiple DRX cycles each with two POs using a flag to indicate whether paging spatial adaptation is used, in accordance with aspects described herein;

FIG. 10 illustrates examples of timelines having multiple DRX cycles each with two POs and using a flag to indicate whether paging spatial adaptation is used when a high priority paging request is received, in accordance with aspects described herein;

FIG. 11 illustrates an example of a timeline having multiple DRX cycles each with two POs using a flag in a low-power wakeup signal (LP-WUS) occasion to indicate whether paging spatial adaptation is used, in accordance with aspects described herein;

FIG. 12 illustrates an example of a timeline having multiple DRX cycles each with two POs using a LP-WUS occasion to indicate whether paging spatial adaptation is used, in accordance with aspects described herein; and

FIG. 13 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to reducing latency in paging signals transmitted using spatial allocation. In wireless communication technologies, such as fifth generation (5G) new radio (NR) or other wireless communication technologies, network, such as base stations/gNBs can transmit paging signals to devices, such as user equipment (UEs), to cause the devices to establish or activate a connection with the network node to receive certain communications. For example, in 5G NR, a UE can use discontinuous reception (DRX) to transition between an ACTIVE state and an IDLE/INACTIVE state in order to reduce power consumption. The UE can remain in a low-power state (e.g., by terminating or otherwise reducing power to the receiver and/or other components of the UE) until an associated timer expires.

When the timer reaches the on-duration, the UE can transition to the ACTIVE state to wake up (e.g., apply power to the receiver and/or other components) to check for incoming data. If the UE detects a paging message or other relevant data, the UE can accordingly process the message and/or respond. After the on-duration, the UE transition back to IDLE/INACTIVE state until the next DRX cycle. The UE can monitor one paging occasion (PO) per DRX cycle. A PO can include a set of physical downlink control channel (PDCCH) monitoring occasions and can include multiple time slots (e.g., subframe or orthogonal frequency division multiplexing (OFDM) symbol) where paging downlink control information (DCI) can be sent. One Paging Frame (PF) can include one radio frame and/or may include one or multiple PO(s) or starting point of a PO. One DRX cycle may have one or more PFs. If time T is the DRX cycle, and N is the number of PFs, then PFs can be separated by time T/N. UE related PF and PO locations can depend on an identifier of the UE.

In addition, in 5G NR, the paging message can be beam-swept in all directions, which can mean that the paging message can be transmitted as multiple signals each in a different beam direction of multiple beam directions over a period of time. This can improve reception of the paging signal by various UEs served by the network node and in different locations around the network node, as the paging message can be transmitted in various spatial directions. The density of UEs in different locations served by the network node (or served using a given beam), however, may not be consistent, and/or a response to a paging message transmitted using a first beam may be received before transmitting the paging message using a second beam. As such, for example, a network node can transmit a paging message in order of most populated spatial direction, as a response is more likely to come from a UE in a more populated spatial direction, which can conserve transmission resources by refraining from transmitting the paging message using other beams where a response is received. In one specific example, the network node can transmit a paging message using a first subset of beams in a first portion of a DRX cycle (also referred to herein as an idle mode DRX (I-DRX) cycle), and if a response is received, the network node can refrain from transmitting the paging message using a second subset of beams. If no response is received, however, the network node can transmit the paging message using the second subset of beams in a second portion of the I-DRX cycle.

In this regard, the network node can distribute the paging monitoring occasions of different beams within the I-DRX cycle. From a UE perspective, each UE, given its identifier and selected synchronization signal block (SSB) beam, can determine which occasion to monitor (one occasion per I-DRX cycle). From the network node perspective, the network node can first send the paging message in the more likely/populated beam directions. If no response, e.g., no random access channel (RACH) Msg3 received with the identifier of the paged UE, within the gap between the two sets of monitoring occasions, the network node can send the paging message in other directions within the same I-DRX cycle. This, however, may increase latency to UE's that are located in areas associated with less-populated beam directions, also referred to herein as low populated beams.

Aspects described herein relate to transmitting paging messages to a UE in multiple POs based on a paging priority associated with the UE. For example, a network node can use the paging priority of the UE to determine whether to possibly send paging messages to the UE in multiple POs in a given DRX cycle. Other aspects relate to the network node transmitting, or the UE receiving, an indication of whether a paging message is transmitted in one of multiple POs of a DRX cycle using all configured beams or a portion of the configured beams. In an example, the UE can accordingly determine whether to receive the paging message during the DRX cycle and/or in which PO to receiving the paging message during the DRX cycle. In this regard, for example, aspects described herein can facilitate reducing latency to the UEs associated with less-populated beam directions and reducing energy consumption at the network node.

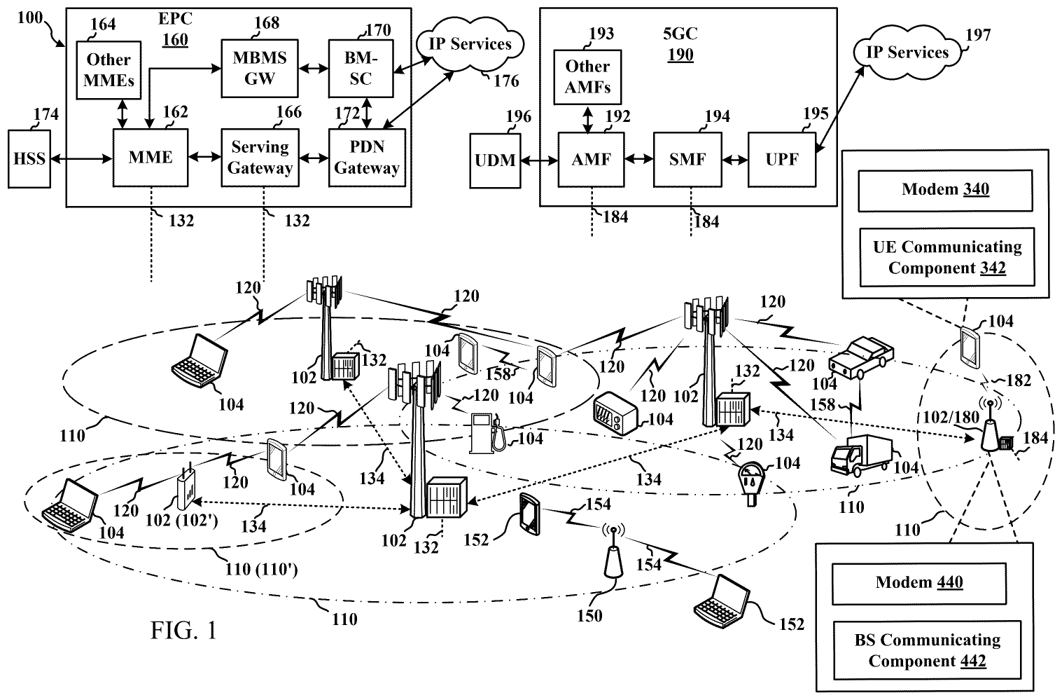

The described features will be presented in more detail below with reference to FIGS. 1-13.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for receiving one or more paging messages in at least one of multiple POs of a DRX cycle, in accordance with aspects described herein. In addition, some nodes may have a modem 440 and BS communicating component 442 for transmitting, for a UE, one or more paging messages in at least one of multiple POs of a DRX cycle, in accordance with aspects described herein. Though a UE 104 is shown as having the modem 340 and UE communicating component 342 and a base station 102/gNB 180 is shown as having the modem 440 and BS communicating component 442, this is one illustrative example, and substantially any node or type of node may include a modem 340 and UE communicating component 342 and/or a modem 440 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, BS communicating component 442 of a base station 102/gNB 180 can transmit, for a UE 104, one or more paging messages in a first PO of a DRX cycle and can transmit, for the UE 104 and based on a paging priority of the UE 104, one or more second paging messages in a second PO of the DRX cycle. In an example, BS communicating component 442 can transmit, and/or UE communicating component 342 can receive an indication of whether one or more paging messages in at least one of the POs are transmitted using all configured beams or a portion of the configured beams. UE communicating component 342, in an example, can determine during or for which POs to receive the one or more paging messages based on the indication.

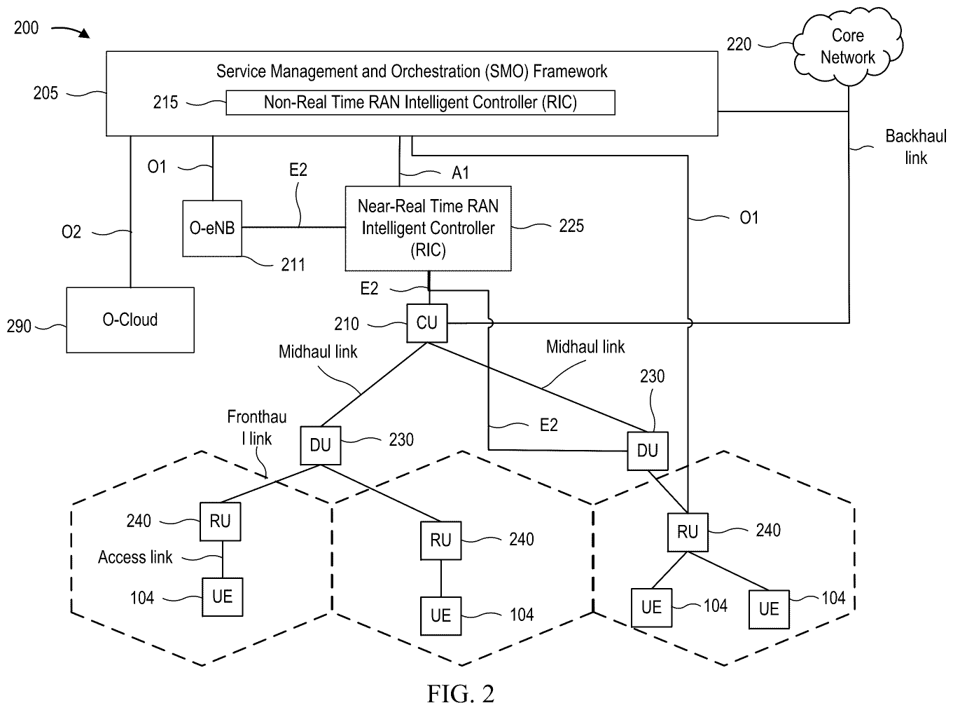

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

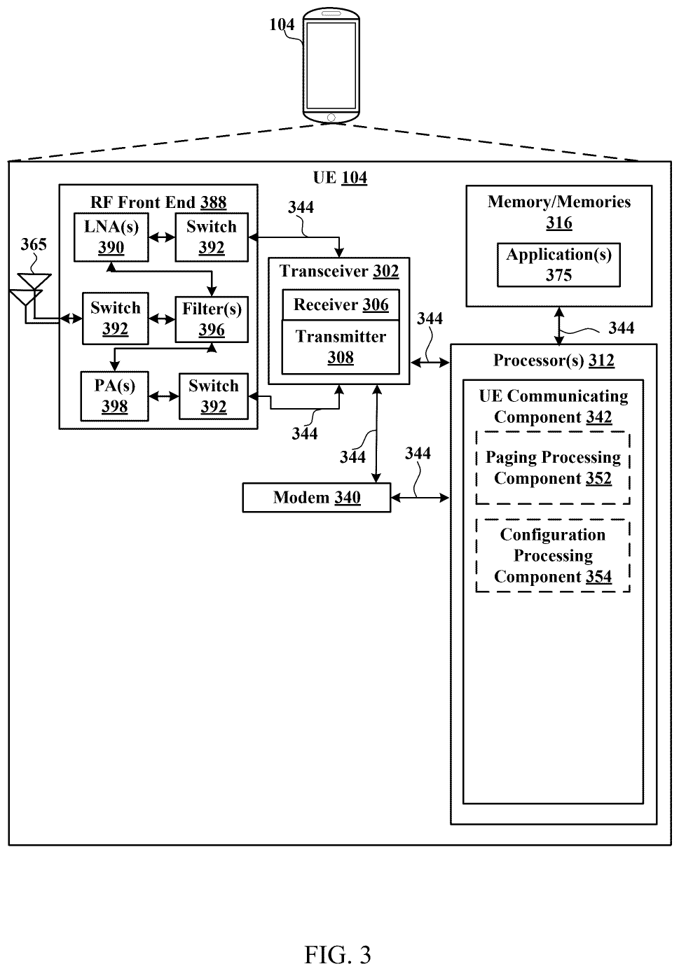

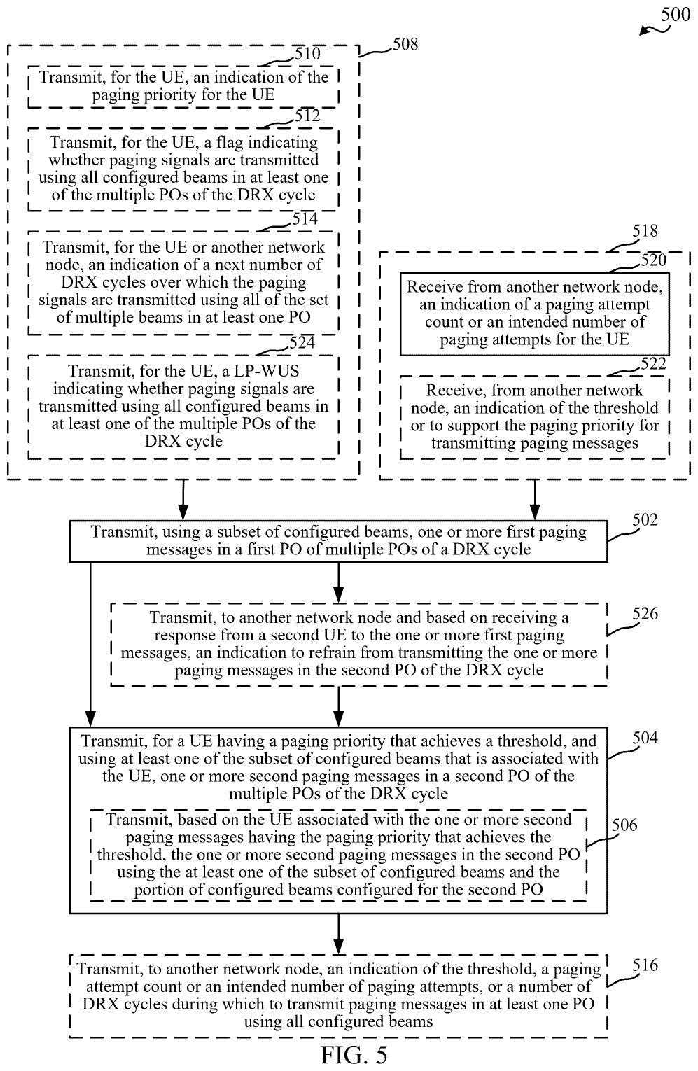

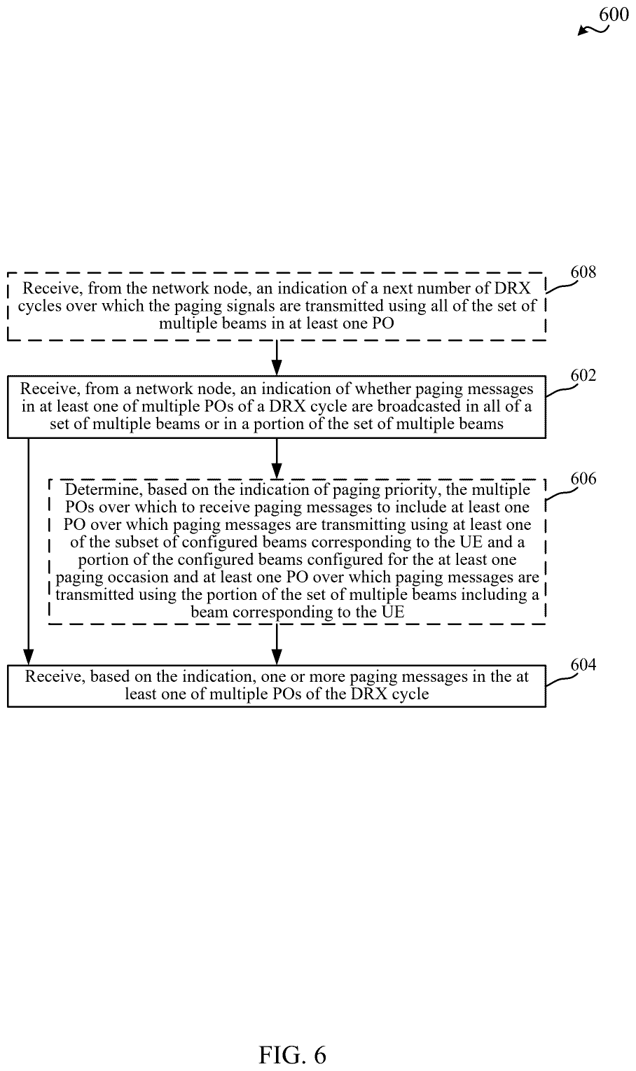

Turning now to FIGS. 3-8, aspects are depicted with reference to one or more components and one or more methods that may perform the actions or operations described herein, where aspects in dashed line may be optional. Although the operations described below in FIGS. 5 and 6 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and one or more memories 316 and one or more transceivers 302 in communication via one or more buses 344. For example, the one or more processors 312 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 316 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 312, one or more memories 316, and one or more transceivers 302 may operate in conjunction with modem 340 and/or UE communicating component 342 for receiving one or more paging messages in at least one of multiple POs of a DRX cycle, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory/memories 316 may be configured to store data used herein and/or local versions of applications 375 or UE communicating component 342 and/or one or more of its subcomponents being executed by at least one processor 312. Memory/memories 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory/memories 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include a paging processing component 352 can receiving and/or processing paging messages from a base station 102/gNB 180, and/or a configuration processing component 354 for receiving and/or processing a configuration indicating one or more parameters for receiving paging messages, in accordance with aspects described herein.

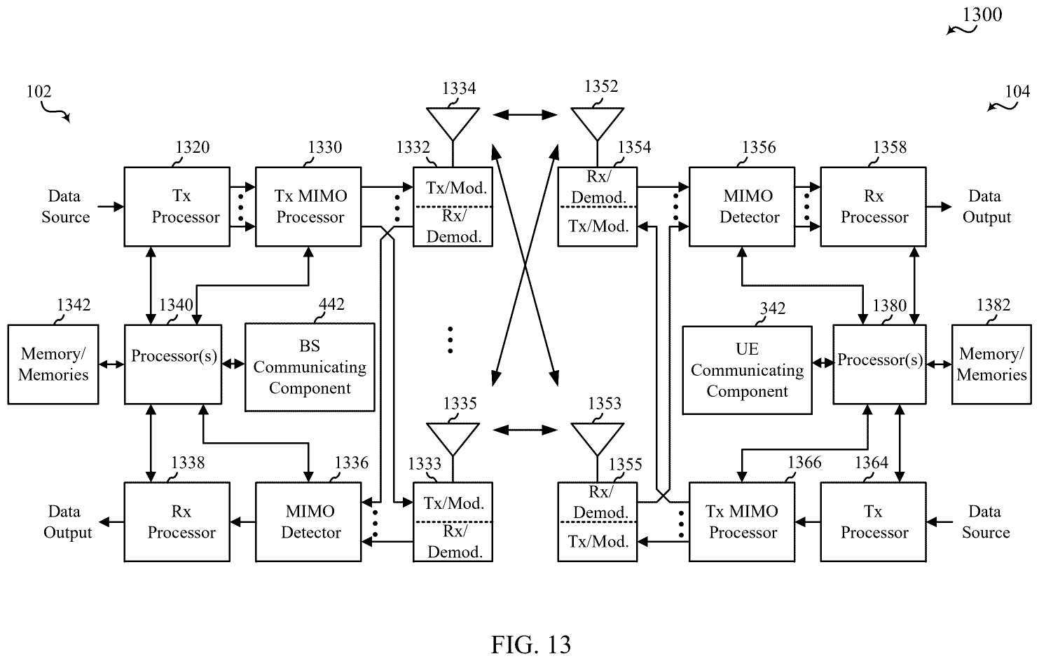

In an aspect, the processor(s) 312 may correspond to one or more of the processors described in connection with the UE in FIG. 13. Similarly, the memory/memories 316 may correspond to the one or more memories described in connection with the UE in FIG. 13.

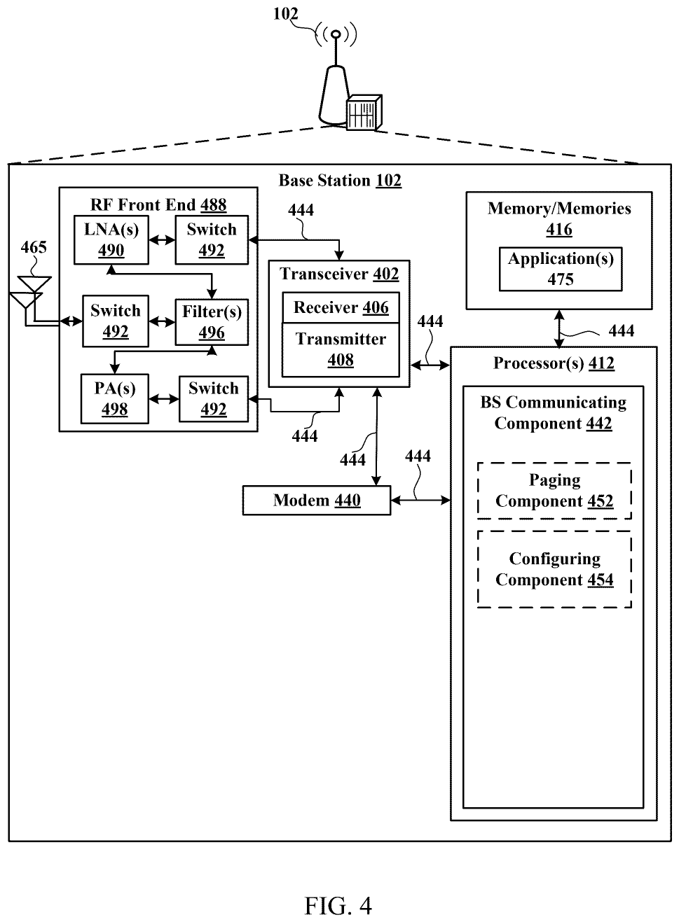

Referring to FIG. 4, one example of an implementation of base station 102 (e.g., a base station 102 and/or gNB 180, as described above) may include a variety of components, some of which have already been described above, but including components such as one or more processors 412 and one or more memories 416 and one or more transceivers 402 in communication via one or more buses 444. For example, the one or more processors 412 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 416 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 412, one or more memories 416, and one or more transceivers 402 may operate in conjunction with modem 440 and/or BS communicating component 442 for transmitting, for a UE, one or more paging messages in at least one of multiple POs of a DRX cycle, in accordance with aspects described herein.

The transceiver 402, receiver 406, transmitter 408, one or more processors 412, memory/memories 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, BS communicating component 442 can optionally include a paging component 452 for transmitting one or more paging messages or associated paging signals for one or more UEs in one or more POs, and/or a configuring component 454 for configuring the one or more UEs to receive the one or more paging messages, in accordance with aspects described herein.

In an aspect, the processor(s) 412 may correspond to one or more of the processors described in connection with the base station in FIG. 13. Similarly, the memory/memories 416 may correspond to the one or more memories described in connection with the base station in FIG. 13.

FIG. 5 illustrates a flow chart of an example of a method 500 for transmitting paging messages in multiple POs, in accordance with aspects described herein. FIG. 6 illustrates a flow chart of an example of a method 600 for receiving and/or processing paging messages in one or multiple POs, in accordance with aspects described herein. In an example, a base station 102 or gNB 180, a monolithic base station or gNB, a portion of a disaggregated base station or gNB, a UE in sidelink communication, etc., can perform the functions described in method 500 shown in FIG. 5 using one or more of the components described in FIGS. 1 and/or 4. In an example, a UE 104 can perform the functions described in method 600 shown in FIG. 6 using one or more of the components described in FIGS. 1 and/or 3. In addition, methods 500 and 600 are described in conjunction with one another for ease of explanation; however, the methods 500 and 600 are not required to be performed together and indeed can be performed independently using separate devices.

In one example, aspects of the network node described herein can be implemented in a CU and/or DU. For example, for a CU having multiple DUs, the DUs can each transmit paging messages for UEs using certain beams in POs. When a response from a UE, the DU receiving the response can forward the response to the CU, and the CU can terminate, or otherwise not instruct the DUs regarding, sending the paging messages on other beams in other POs of the same DRX cycle. Having the multiple DUs skip paging in low-populated beams when a response is received via one DU can further save more energy by the other DUs of the same CU not transmitting the paging message in the subsequent POs.

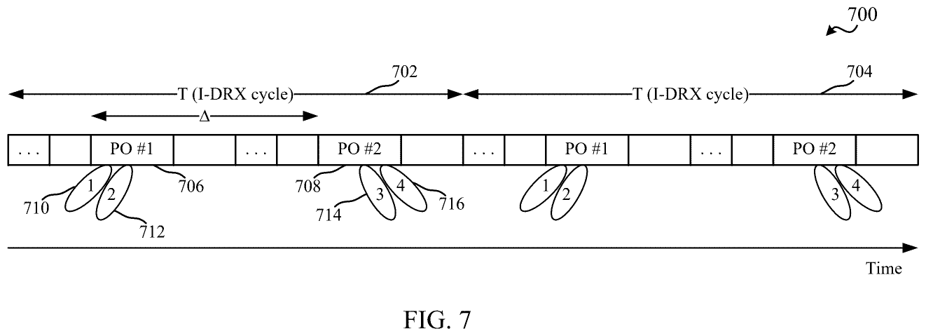

In method 500, at Block 502, one or more first paging messages can be transmitted, using a subset of configured beams, in a first PO of multiple POs of a DRX cycle. In an aspect, paging component 452, e.g., in conjunction with processor(s) 412, memory/memories 416, transceiver 402, BS communicating component 442, etc., can transmit, using the subset of configured beams, one or more first paging messages in the first PO of multiple POs of the DRX cycle. For example, each DRX cycle can have multiple POs, where the DRX cycle and POs can be defined in a wireless communication technology, such as 5G NR. For example, the DRX cycle can be defined by a number of time instances, such as a number of OFDM symbols, a number of subframes, etc., and each PO can be defined as a number time instances (e.g., a number OFDM symbols, a number of subframes, etc.), within the number of time instances that define the DRX cycle. An example is shown in FIG. 7, which depicts a timeline 700 including a time periods T defined as I-DRX cycles 702 and 704 each having two POs—PO #1 and PO #2.

In addition, the network node can configure multiple beams to use in transmitting paging messages to UEs. For example, the network node can indicate parameters corresponding to the multiple beams in a configuration transmitted to the UEs, such as a beam identifier, an indication of time resources over which the beam is used to transmit the paging messages, etc. In an example, the network node can transmit the configuration to the UE in radio resource control (RRC) signaling, in broadcast system information, in a media access control (MAC)-control element (CE), in downlink control information (DCI), etc. In addition, in an example, the network node can configure, for the UEs, an indication of the beams used to transmit the paging message(s) in each of the POs within a given DRX cycle. For example, referring to FIG. 7, the network node can transmit, for the UEs, a configuration indicating that beam 1 710 and beam 2 712 are used to transmit paging messages in PO #1 706, and beam 3 714 and beam 4 716 are used to transmit paging messages in PO #2 708 in each DRX cycle (or at least in DRX cycle 702). This can be referred to as paging spatial adaptation (or reduced paging), as opposed to legacy paging where all configured beams are transmitted in a PO in the DRX cycle.

In method 500, at Block 504, one or more second paging messages can be transmitted, for a UE having a paging priority that achieves a threshold and using at least one of the subset of configured beams that is associated with the UE, in a second PO of the multiple POs of the DRX cycle. In an aspect, paging component 452, e.g., in conjunction with processor(s) 412, memory/memories 416, transceiver 402, BS communicating component 442, etc., can transmit, for the UE having a paging priority that achieves the threshold and using at least one of the subset of configured beams that is associated with the UE, the one or more second paging messages in the second PO of the multiple POs of the DRX cycle. For example, a paging priority information element (IE) may be included in a paging message, and if present the gNB-DU may use the indication for the paging process, an example of which is specified in third generation partnership project (3GPP) technical specification (TS) TS 23.501.

For example, paging priority can be a feature that allows the AMF to include an indication in the Paging Message sent to NG-RAN (e.g., a network node, such as a base station or gNB) that the UE is to be paged with priority. The decision by the AMF whether to include Paging Priority in the Paging Message can be based on the allocation and retention priority (ARP) value in the message received from the SMF for an IP packet waiting to be delivered in the UPF. For a UE in RRC Inactive state, the NG-RAN can determine Paging Priority based on the ARP associated with the quality-of-service (QoS) Flow as provisioned by the operator policy, and the Core Network Assisted RAN paging information from AMF. The QoS parameter ARP can include information about the priority level, the pre-emption capability and the pre-emption vulnerability. The ARP priority level can define the relative importance of a QoS Flow. The range of the ARP priority level can be one to 15, with one as the highest priority.

FIG. 7 illustrates an example of a timeline 700 having multiple DRX cycles 702 and 704 each with two POs—PO #1 706 and PO #2 708—using paging spatial adaptation, in accordance with aspects described herein. As described, in timeline 700, different beams can be used to transmit paging messages in the POs. In an example, paging component 452 can reduce latency in transmitting paging messages for priority UEs (e.g., UEs having a paging priority that achieves a threshold). For example, delaying paging in less-likely beam directions may be adopted only for low-priority paging (e.g., UEs having a paging priority that does not achieve the threshold). In an example, the priority in the paging may rely on the QoS and data type and/or on the UE type (priority UE or not) (e.g., low latency UEs etc.). If a paging request arrives (e.g., from an AMF or other network node) for a UE having a high priority (e.g., priority that achieves the paging priority threshold), paging component 452 can send the paging message in the next PO without waiting for the next DRX cycle, which can reduce the delay for those UEs in the low populated beams. Thus, for example, for UEs having high paging priority and using beam 3 or 4, if a paging message for such a UE is received after PO #1 706, paging component 452 can transmit the paging message using beam 3 714 and/or beam 4 716 in PO #2 708 without waiting for the next DRX cycle 704. This can be implemented transparently to the UE (e.g., the UE need not to know whether the arriving paging is with high priority).

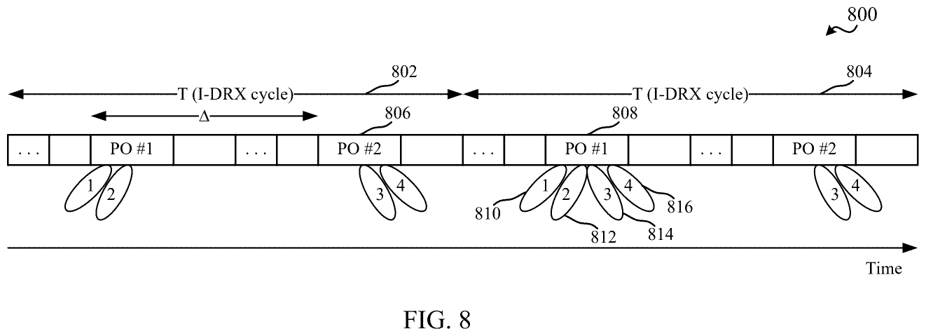

In another example, in transmitting the one or more second paging messages at Block 504, optionally at Block 506, the one or more second paging messages can be transmitted, based on the UE associated with the one or more second paging messages having the paging priority that achieves the threshold, in the second PO using at least one of the subset of configured beams and the portion of configured beams configured for the second PO. In an aspect, paging component 452, e.g., in conjunction with processor(s) 412, memory/memories 416, transceiver 402, BS communicating component 442, etc., can transmit, based on the UE associated with the one or more second paging messages having the paging priority that achieves the threshold, the one or more second paging messages in the second PO using at least one of the subset of configured beams and the portion of configured beams configured for the second PO. In this example, the paging component 452 transmits the paging message using the subset of configured beams in a first PO and using at least one of the subset of configured beams and the portion of configured beams configured for the second PO where paging for the high priority is received before the second PO (the first and second PO can be any POs in the DRX cycle, and need not be the first occurring and second occurring POs). In one example, the at least one of the subset of configured beams and the portion of configured beams configured for the second PO can include all configured beams. An example is shown in FIG. 8.

FIG. 8 illustrates an example of a timeline 800 having multiple DRX cycles 802 and 804 each with two POs—PO #1 806 and PO #2 808—using paging spatial adaptation with priority paging, in accordance with aspects described herein. As described, in timeline 800, different beams can be used to transmit paging messages in the POs. In an example, paging component 452 can reduce latency in transmitting paging messages for priority UEs (e.g., UEs having a paging priority that achieves a threshold) by transmitting paging messages for such UEs using all configured beams. If a paging message arrives (e.g., at a physical layer or MAC layer of the network node) with a high priority (e.g., priority higher than a threshold), paging component 452 can send the paging message in the next PO using all beams without waiting for the next DRX cycle or the appropriate PO configured for transmitting the paging message using the beam for the high priority UE. Thus, for example, for UEs having a paging priority that achieves the paging priority threshold and using a low populated beam (e.g., beam 3 or 4), if a paging request for such a UE is received (e.g., from another network node, such as a AMF) after PO #2 806 in DRX cycle 802, paging component 452 can transmit the paging message using beam 3 814 and/or beam 4 816, along with the other configured beams beam 1 810 and beam 2 812, in PO #1 808 of DRX cycle 804 without waiting for PO #2 of DRX cycle 804. In this example, the network node can indicate, to the UE, the paging priority so the UE can determine during which POs it may receiving paging messages.

In some examples described herein, transmitting the paging messages can be based on transmitting one or more other messages, configurations, or parameter values, etc. to the UE, as shown in Block 508. In an example, in method 500, optionally at Block 510, an indication of the paging priority for the UE can be transmitted for the UE. In an aspect, configuring component 454, e.g., in conjunction with processor(s) 412, memory/memories 416, transceiver 402, BS communicating component 442, etc., can transmit, for the UE, the indication of the paging priority for the UE. In this example, the UE can receive and use the paging priority to determine the POs over which the network node can possibly transmit paging messages for the UE. Thus, for example, the network node can divide UEs into high priority UEs (VIP UEs) and low priority UEs (non-VIP UEs). From the UE prospective, high priority UEs can monitor for paging on PO #1 regardless of beams. From the network node prospective, if the network node receives a paging message for transmitting with high priority, the network node can send the paging in all directions on the next PO #1, as shown in FIG. 8. In an example, configuring component 454 can use signaling to inform a UE with its priority (e.g., authorize the UE to use this feature). In one example, the network node can configure or receive an indication of a paging priority for one or more UEs. For UEs having a paging priority that achieves a threshold (e.g., a high paging priority), paging component 452 can transmit a paging signal for the UE (e.g., using a beam associated with the UE) in a PO within which the beam is not indicated as configured.

In this example, UEs configured in this regard can benefit from a reduced false alarm rate compared to other UEs that monitor for paging on contended paging occasions. This provides special treatment to those UEs, which may include an incentive or in return to assistance provided by the VIP UEs to the NW, e.g., in other contexts. For example, the configuring component 454 can configure the indication for the UEs using dedicated signaling in prior connection, e.g., non-access stratum (NAS) or RRC or user plane (UP), in which case authorization to use the multiple paging occasions can use dedicated UE signaling. In another example, the configuring component 454 can configure the indication for the UEs using system information (e.g., system information block (SIB) defined in 5G NR), in which case authorization to use the multiple paging occasions may be per UE class or UE category or authorized services for the UE, etc. In another example, system information of the network node, or a provided cell, may carry an indication whether dedicated authorization to use the multiple paging occasions applies to the cell and/or is overridden by the cell. In another example, the system information may indicate whether extra paging configuration in the system info applies to all capable UEs or only the UEs authorized or configured to use the multiple paging occasions. In yet another example, configuring component 454 can configure the indication for the UEs using intra-network messages, such as a paging request from higher-tier node to lower-tier node that may include indication whether a UE is authorized to use the multiple paging occasions.

In an example, in method 500, optionally at Block 512, a flag indicating whether paging signals are transmitted using all configured beams in at least one of the multiple POs of the DRX cycle can be transmitted for the UE. In an aspect, configuring component 454, e.g., in conjunction with processor(s) 412, memory/memories 416, transceiver 402, BS communicating component 442, etc., can transmit, for the UE, the flag indicting whether paging signals are transmitted using all configured beams in at least one of the multiple POs of the DRX cycle (e.g., whether the DRX or PO follows legacy paging using all configured beams or follows a paging spatial adaptation using a portion of the configured beams). For example, configuring component 454 can configure paging spatial adaptation for most scenarios (e.g., as a default) and can configure legacy paging where the paging requests for UEs having high paging priority are received. In an example, the flag can be a binary value having one value (e.g., 0) that indicates legacy paging (e.g., paging using all configured beams in one or more POs of the DRX cycle) or another value (e.g., 1) that indicates reduced paging for the DRX cycle.

For example, configuring component 454 can broadcast the flag to all UEs on using all configured beams at the beginning of a DRX cycle. In an example, the flag may indicate a value, N, of a next number DRX cycles that follow legacy paging or reduced paging (e.g., paging spatial adaptation), or may be a binary flag that indicates whether a value, N, of a next number of DRX cycles follow legacy paging or reduced paging. In one example, configuring component 454 can configure N=0, which can mean the flag indicates the status of the current DRX cycle. In this example, in method 500, optionally at Block 514, an indication of a next number of DRX cycles over which the paging signals are transmitted using all of the set of multiple beams in at least one PO can be transmitted for the UE or another network node. In an aspect, configuring component 454, e.g., in conjunction with processor(s) 412, memory/memories 416, transceiver 402, BS communicating component 442, etc., can transmit, for the UE or (as described in further detail below) for another network node, the indication of the next number of DRX cycles (N) over which the paging signals are transmitted using all of the set of multiple beams in at least one PO.

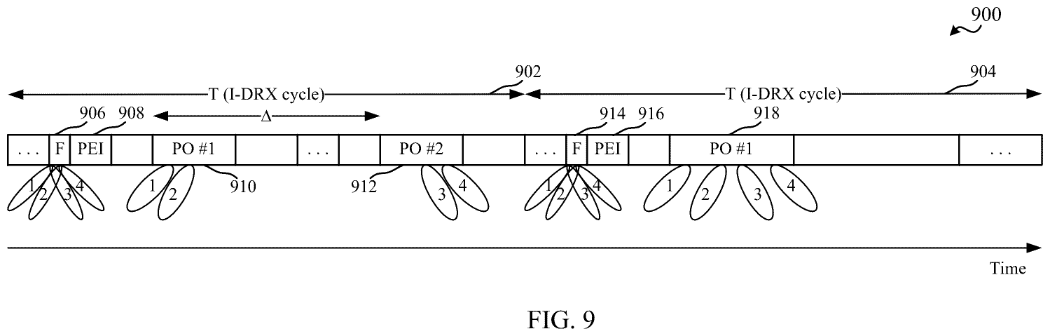

If a paging arrives (e.g., at the network node and from an AMF or other upstream network node) with high priority for a UE, configuring component 454 can activate the flag to switch back to legacy paging and paging component 452 can use legacy paging in a DRX cycle; otherwise, paging component 452 can maintain using the paging spatial adaptation in the DRX cycle. In this regard, delay for those UEs in the less-populated beams can be reduced. In one specific example, the flag can be associated with paging early indication (PEI), such that configuring component 454 can send PEI (with the flag) at the beginning of each DRX cycle, which can indicate whether to use legacy paging or paging spatial adaptation in all POs in the DRX cycle. In addition, in an example, configuring component 454 can broadcast PEI (with the flag) to all UEs on all configured beams. An example is shown in FIG. 9.

FIG. 9 illustrates an example of a timeline 900 having multiple DRX cycles 902 and 904 each with two POs using a flag to indicate whether paging spatial adaptation is used, in accordance with aspects described herein. In timeline 900, configuring component 454 can transmit a flag 906 using all configured beams before, or with (or including), transmitting a PEI 908. The flag 906 is associated with DRX cycle 902 and indicates that paging spatial adaptation is used in DRX cycle 902 to transmit paging messages using a first portion of configured beams in PO #1 910 and transmit the paging messages using a second portion of configured beams in PO #2 912. For DRX cycle 904, a flag 914 can be transmitted using all configured beams before, or with (or including), transmitting a PEI 916, where the flag 914 can indicate that legacy paging is used in DRX cycle 904 to transmit paging messages using all configured beams in PO #1 918. For example, configuring component 454 can transmit the flag 914 to indicating using all configured beams based on receiving a paging request from another network node (e.g., AMF) for a UE having a priority that achieves the paging priority threshold, where the request is received after PO #2 912 in DRX cycle 902, or otherwise during DRX cycle 902 without receiving a corresponding response to the paging message from the UE.

In some examples, the flag can indicate whether the next N DRX cycles, the cell follows legacy paging or paging spatial adaptation. There may be various trigger events that motivate the network node to set N>0. For example, if the network node, or corresponding cell, receives at least a threshold number of paging requests with high priority, configuring component 454 may decide to set N>0 (e.g., switching back to legacy paging in the next N DRX cycles to reduce latency). In addition, in this example, the network node may share the value of N with other network nodes. The value of the N may be cell specific, beam specific, time and/or location specific, etc. Configuring component 454 may also inform the UE as to the current value of the N (e.g., by broadcasting in SIB1 or in any other SI), as described herein.

In accordance with aspects described herein, the threshold value for the paging priority described above may be based on QoS, data type, and/or UE type. In some examples, there may also be other parameters that can determine the priority of the UE such as Paging attempt. For example, AMF or another network node in a first network (e.g., a first NG-RAN), when sending a paging message to another network node (e.g., a second NG-RAN), to page a UE, may include a paging attempt count value and/or an intended number of paging attempts value. In this example, if the network node receives Paging Attempt Count, k, and Intended Number of Paging Attempts, K, for a UE to be paged, paging component 452 can send paging messages with high priority if k>K or generally for k>K−X, where X can be an integer or other value that represents a priority of the UE, such that as X increases, the priority of the UE increases. In an example, X can be UE-specific such that it is set for the UE (e.g., by the UE or by a core network node) regardless of cell, or X can be cell-specific and can be used to change the priority threshold for the cell for determining paging type (e.g., legacy or paging spatial adaptation) for UEs served by the cell.

In addition, in some examples, new signaling between AMF and NG-RAN (e.g., for core network (CN) paging), or between NG-RANs (e.g., for RAN paging) can be supported. The signaling can indicate whether paging with priority can be implemented for paging a UE, where such an indication can be cell-specific or beam-specific (from low-populated beams). The signaling can indicate the criteria for which paging with priority can be implemented (e.g., information described above for certain conditions, such as X, threshold for paging priority, N, etc.), which can be UE-specific, cell-specific, and/or beam-specific. Moreover, for example, the information can be shared between network entities or nodes. For example, the paging priority threshold may be chosen by AMF/CU/another CN functionality and provided to the DU, or DU may determine the paging priority threshold and notify the other entities about the determined threshold.

In an example, to facilitate the above signaling, in method 500, optionally at Block 516, an indication of the threshold, a paging attempt count or an intended number of paging attempts, or a number of DRX cycles during which to transmit paging messages in at least one PO using all configured beams can be transmitted to another network node. In an aspect, configuring component 454, e.g., in conjunction with processor(s) 412, memory/memories 416, transceiver 402, BS communicating component 442, etc., can transmit, to another network node (e.g., another NG-RAN), an indication of the threshold (e.g., paging priority threshold), a paging attempt count, k, or intended number of paging attempts, K, or a number of DRX cycles during which to transmit paging message in at least one PO using all configured beams, N. For example, configuring component 454 can transmit such information to another network node using backhaul or other signaling.

In another example, transmitting the paging messages can be based on receiving one or more other messages, configurations, or parameter values, etc. from another network node, such as another NG-RAN or an upstream network node, such as an AMF, as shown in Block 518. In an example, in method 500, optionally at Block 520, an indication of a paging attempt count or an intended number of paging attempts for the UE can be received from another network node. In an aspect, configuring component 454, e.g., in conjunction with processor(s) 412, memory/memories 416, transceiver 402, BS communicating component 442, etc., can receive, from another network node (e.g., NG-RAN, AMF, etc.), the indication of the paging attempt count, k, or the intended number of paging attempts, K, for the UE. As described above, configuring component 454 can determine whether to configure the UE to use legacy paging or paging spatial adaptation in a DRX cycle and/or POs thereof based on the indication, and/or can accordingly configure the UE.

In another example, in method 500, optionally at Block 522, an indication of the threshold or to support the paging priority for transmitting paging messages can be received from another network node. In an aspect, configuring component 454, e.g., in conjunction with processor(s) 412, memory/memories 416, transceiver 402, BS communicating component 442, etc., can receive, from another network node (e.g., NG-RAN, AMF, etc.), the indication of the threshold (e.g., the paging priority threshold) or to support the paging priority for transmitting paging messages. As described above, configuring component 454 can determine whether to configure the UE to use legacy paging or paging spatial adaptation in a DRX cycle and/or POs thereof based on the received indication of the paging priority threshold or to support the paging priority, and/or can accordingly configure the UE.

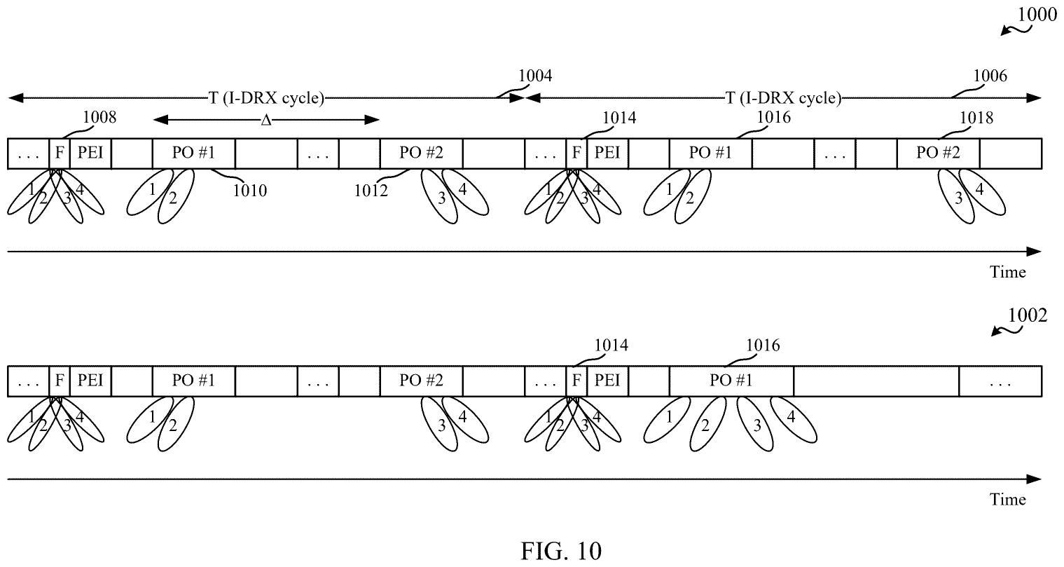

FIG. 10 illustrates examples of timelines 1002 and 1004 having multiple DRX cycles 902 and 904 each with two POs and using a flag to indicate whether paging spatial adaptation is used when a high priority paging request is received, in accordance with aspects described herein. In timeline 1000, configuring component 454 can transmit a flag 1008 associated with DRX cycle 1002 to indicate that paging spatial adaptation is used in DRX cycle 1002 to transmit paging messages using a first portion of configured beams in PO #1 1010 and transmit the paging messages using a second portion of configured beams in PO #2 1012. Similarly, for DRX cycle 1004, configuring component 454 can transmit a flag 1014 associated with DRX cycle 1004 to indicate that paging spatial adaptation is used in DRX cycle 1004 to transmit paging messages using a first portion of configured beams in PO #1 1016 and transmit the paging messages using a second portion of configured beams in PO #2 1018. This can be the case when a paging request is received (e.g., from an upstream node, such as an AMF) to page a UE having high priority and low populated beam (e.g., beam 3 or 4) between PO #1 1010 and PO #2 1012. In this example, paging component 452 can page the UE in the next PO 1012. In timeline 1002, however, the paging request can be received (e.g., from an upstream node, such as an AMF) to page a UE having high priority and low populated beam (e.g., beam 3 or 4) after PO #2 1012. In this example, configuring component 454 can configure the DRX cycle 1006 for legacy paging or to otherwise transmit the paging message using all configured beams in PO #1 1016, by using the flag 1014 to indicate legacy paging in DRX cycle 1006.

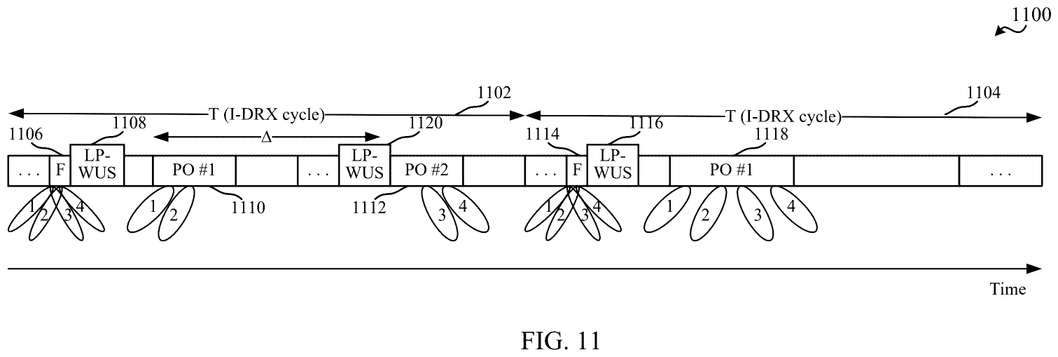

In an example, in method 500, optionally at Block 524, a low power (LP)-wake-up signal (WUS) indicating whether paging signals are transmitted using all configured beams in at least one of the multiple POs of the DRX cycle can be transmitted for the UE. In an aspect, configuring component 454, e.g., in conjunction with processor(s) 412, memory/memories 416, transceiver 402, BS communicating component 442, etc., can transmit, for the UE, a LP-WUS indicating whether paging signals are transmitted using all configured beams in at least one of the multiple POs of the DRX cycle. For example, LP-WUS can be used to indicate if there is a paging or not for the UEs and explicitly indicate the priority of the paging. An example is shown in FIG. 11.

FIG. 11 illustrates an example of a timeline 1100 having multiple DRX cycles 1102 and 1104 each with two POs using a flag in a LP-WUS occasion to indicate whether paging spatial adaptation is used, in accordance with aspects described herein. In timeline 1100, configuring component 454 can transmit a flag 1106 using all configured beams before, or with (or including), transmitting a LP-WUS 1108. The flag 1106 is associated with DRX cycle 1102 and indicates that paging spatial adaptation is used in DRX cycle 1102 to transmit paging messages using a first portion of configured beams in PO #1 1110 and transmit the paging messages using a second portion of configured beams in PO #2 1112. For DRX cycle 1104, a flag 1114 can be transmitted using all configured beams before, or with (or including), transmitting a LP-WUS 1116, where the flag 1114 can indicate that legacy paging is used in DRX cycle 1104 to transmit paging messages using all configured beams in PO #1 1118. For example, configuring component 454 can transmit the flag 1114 to indicating using all configured beams based on receiving a paging request from another network node (e.g., AMF) for a UE having a priority that achieves the paging priority threshold, where the request is received after PO #2 1112 in DRX cycle 1102, or otherwise during DRX cycle 1102 without receiving a corresponding response to the paging message from the UE.

For example, monitoring LP-WUS (using LP-wake-up receiver (WUR)) can be less expensive for a UE from a hardware and/or resource cost perspective. As such, for example, configuring component 454 can configure UEs (associated with low populated beams, or effectively beams 3 or 4 transmitted in PO #2 in examples described above and further herein) to monitor LP-WUS in two occasions—one occasion which is common with UEs of PO #1 (a priority flag 1114 is sent in this occasion), and one occasion associated with (and before) PO #2 (may not need priority flag for this PO). Upon arrival of a high-priority paging request from a network node (e.g., AMF), configuring component 454 can transmit LP-WUS in the first occasion and in all configured beam directions and can notify all the UEs to monitor PO #1 1116. The UEs in low-density beams can skip monitoring a second LP-WUS and paging occasion. Upon arrival of a low-priority paging request from the network node (e.g., AMF), configuring component 454 can transmit LP-WUS in the first occasion and in all configured beam directions, the flag 1106 can be set to 0. Paging component 452 can alert the UEs using low population beams that there may be a paging. These UEs can monitor LP-WUS 1120 in the second occasion to see if there will be a paging in PO #2 1112.

In this example, as previously described, the paged UE may likely be found and a response received therefrom prior to PO #2 1112, and having the second LP-WUS 1120 monitoring can be beneficial for the UEs in the low-populated beams to avoid unnecessarily powering on radio resources in the second PO 1112. In addition, in this example, when there is no paging, the UEs in low-populated beams can become aware by monitoring first LP-WUS occasion and not detecting any paging messages for other UEs. In this example, these UEs can skip the second LP-WUS 1120 monitoring, which can further reduce UE energy but may increase the latency if the paging response arrives between PO #1 1110 and PO #2 1120 for low density beams UEs, as in this case, paging is sent in the next DRX cycle 1104.

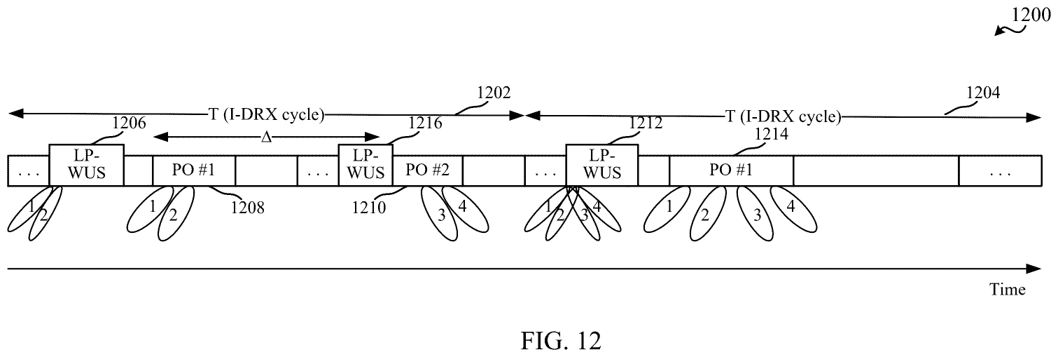

In another example, LP-WUS can be used to indicate if there is a paging or not for the UEs and implicitly indicate the priority of the paging. An example is shown in FIG. 12. FIG. 12 illustrates an example of a timeline 1200 having multiple DRX cycles 1202 and 1204 each with two POs using a LP-WUS occasion to indicate whether paging spatial adaptation is used, in accordance with aspects described herein. In timeline 1200, configuring component 454 can transmit a LP-WUS 1206 in beam directions over which the paging message is transmitted in a corresponding PO #1 1208. LP-WUS 1206 can be sent using configured beams 1 and 2, and as such, paging messages in associated PO #1 1208 can also be send using configured beams 1 and 2. LP-WUS 1216 can be sent using configured beams 3 and 4, and as such, paging messages in associated PO #2 1210 can also be send using configured beams 3 and 4. LP-WUS 1212 can be sent using configured beams 1, 2, 3, and 4, and as such, paging messages in associated PO #1 1214 can also be send using configured beams 1, 2, 3, and 4.

For example, the UEs (associated with low-density beams or effectively PO #2) can be configured to monitor LP-WUS in two occasions—one occasion which is common with UEs of PO #1 1208 (sent in all configured beam directions if a paging request arrives for a UE having a paging priority that achieves a threshold, or otherwise in beam directions corresponding to high-populated beams), and one occasion associated with (and before) PO #2 1210. Upon arrival of a paging request for a UE having a high paging priority, configuring component 454 can transmit LP-WUS 1212 in the first occasion and in all configured beam directions and notify all the UEs to monitor PO #1 1212. The UEs using low-populated beams can skip monitoring the second LP-WUS and paging occasion. Upon arrival of a paging request for a UE having a low paging priority (e.g., a priority that does not achieve the paging priority threshold), configuring component 454 can transmit LP-WUS in the first occasion and only in beam directions corresponding to the high-population beams (e.g., beams 1 and 2). UEs that use the low-population beams may not detect LP-WUS 1206 in the first occasion and thus may monitor the second LP-WUS occasion for LP-WUS 1216. This can increase the UE energy consumption, can but reduce paging latency if the paging request for a UE having low paging priority arrives between PO #1 1208 and PO #2 1210 (e.g., paging can be sent in the current DRX cycle 1202). In the above examples, detection of LP-WUS 1212 in the first occasion and in low-density beams means paging component 452 transmits the paging messages for UEs having high paging priority in PO #1 1214.

In method 500, optionally at Block 526, an indication to refrain from transmitting the one or more paging messages in the second PO of the DRX cycle can be transmitted, to another network node and based on receiving a response from a second UE to the one or more first paging messages. In an aspect, configuring component 454, e.g., in conjunction with processor(s) 412, memory/memories 416, transceiver 402, BS communicating component 442, etc., can transmit, to another network node and based on receiving the response from the second UE to the one or more first paging messages, the indication to refrain from transmitting the one or more paging messages in the second PO of the DRX cycle. For example, configuring component 454 can transmit the indication to a CU for transmitting to other DUs, such that the other DUs can refrain from transmitting the one or more paging messages to further conserve radio resources and signaling to UEs.

Referring to FIG. 6, in method 600, at Block 602, an indication of whether paging messages in at least one of multiple POs of a DRX cycle are broadcasted in all of a set of multiple beams or in a portion of the set of multiple beams can be received from the network node. In an aspect, configuration processing component 354, e.g., in conjunction with processor(s) 312, memory/memories 316, transceiver 302, UE communicating component 342, etc., can receive and/or process, from the network node, the indication of whether paging messages in at least one of multiple POs of a DRX cycle are broadcasted in all of the set of multiple beams or in a portion of the set of multiple beams. For example, the set of multiple beams can correspond to the beams configured by the network node for transmitting paging messages, as described above. The indication, as described above, can include various indications (e.g., indications and/or flags transmitted at Block 510, 512, 514, and/or 524 in method 500 described in FIG. 5), such as a paging priority for the UE, an indication sent with or before a PEI, an indication sent with or before a LP-WUS, the LP-WUS itself as an implicit indication, etc. In any case, the indication can allow the UE to determine which POs to monitor for paging messages and/or which beams are used to transmit paging messages in each PO (e.g., whether legacy paging is used in a PO or paging spatial adaptation is used in the PO), etc.

In method 600, at Block 604, one or more paging messages in the at least one of multiple POs of the DRX cycle can be received. In an aspect, paging processing component 352, e.g., in conjunction with processor(s) 312, memory/memories 316, transceiver 302, UE communicating component 342, etc., can receive, based on the indication, the one or more paging messages in the at least one of multiple POs of the DRX cycle. For example, paging processing component 352 can receive one or more paging messages in the one or more POs using legacy paging or paging spatial adaptation based on the indication(s) or flag(s) received from the network node (e.g., at Block 602). In this example, paging processing component 352 can also determine a beam to use in receiving the one or more paging messages, a time period associated with the PO for receiving the one or more paging messages, etc. based on the indication received from the network node.

In one example, the indication can include a paging priority assigned to the UE for receiving paging messages, as described above. In method 600, optionally at Block 606, the multiple POs over which to receive paging messages can be determined, based on an indication of paging priority, to include at least one PO over which paging messages are transmitted using at least one of the subset of configured beams corresponding to the UE and a portion of the configured beams configured for the at least one paging occasion and at least one PO over which paging messages are transmitted using the portion of the set of multiple beams including a beam corresponding to the UE. In an aspect, paging processing component 352, e.g., in conjunction with processor(s) 312, memory/memories 316, transceiver 302, UE communicating component 342, etc., can determine, based on the indication of paging priority, the multiple POs over which to receive paging messages to include at least one PO over which paging messages are transmitted using at least one of the subset of configured beams corresponding to the UE 104 and a portion of the configured beams configured for the at least one paging occasion and at least one PO over which paging messages are transmitted using the portion of the set of multiple beams including a beam corresponding to the UE 104.

For example, where the indication indicates that the UE 104 has high paging priority (e.g., a paging priority level that achieves a threshold), configuration processing component 354 can determine the POs during which the UE 104 is to monitor for paging messages to include substantially all configured POs, or at least a next PO that is not configured for a beam direction of the UE 104. As described above, in one example, configuration processing component 354 can receive the indication as VIP signaling from the network node.

In another example, the indication or flag received from the network node may include a latency reduction flag, which may be sent with or in a PEI or otherwise. In this example, configuration processing component 354 can determine which POs to monitor for paging messages based on whether the latency reduction flag is set or received, and/or based on a number of DRX cycles, N, to which the latency reduction is to be applied. In this example, in method 600, optionally at Block 608, an indication of a next number of DRX cycles over which the paging signals are transmitted using all of the set of multiple beams in at least one PO can be received from the network node. In an aspect, configuration processing component 354, e.g., in conjunction with processor(s) 312, memory/memories 316, transceiver 302, UE communicating component 342, etc., can receive, from the network node, the indication of the next number of DRX cycles (e.g., N) over which the paging signals are transmitted using all of the set of multiple beams in at least one PO. In this regard for example, as described above, the indication can indicate whether the next N DRX cycles, the cell follows legacy paging or paging spatial adaptation (e.g., if there is a paging signal in the next PO for a high priority UE), and/or such that N=0 can indicate the status of the current DRX cycle. When paging spatial adaptation is indicated as activated, for example, paging processing component 352 can monitor the additional POs for paging signals regardless of which POs are configured for the UE 104 beam direction in legacy paging.

In yet another example, the indication can include a LP-WUS that explicitly or implicitly indicates if latency reduction (or paging spatial adaptation) is activated (e.g., if there is a paging signal in the next PO for a high priority UE). Based on the LP-WUS, as described above, paging processing component 352 can process paging messages in one or more POs in a DRX cycle associated with the LP-WUS.

FIG. 13 is a block diagram of a MIMO communication system 1300 including a base station 102 and a UE 104. The MIMO communication system 1300 may illustrate aspects of the wireless communication access network 100 described with reference to FIG. 1. The base station 102 may be an example of aspects of the base station 102 described with reference to FIG. 1. The base station 102 may be equipped with antennas 1334 and 1335, and the UE 104 may be equipped with antennas 1352 and 1353. In the MIMO communication system 1300, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 1320 may receive data from a data source. The transmit processor 1320 may process the data. The transmit processor 1320 may also generate control symbols or reference symbols. A transmit MIMO processor 1330 may perform spatial processing (e.g., precoding) on data symbols, control symbols, or reference symbols, if applicable, and may provide output symbol streams to the transmit modulator/demodulators 1332 and 1333. Each modulator/demodulator 1332 through 1333 may process a respective output symbol stream (e.g., for OFDM, etc.) to obtain an output sample stream. Each modulator/demodulator 1332 through 1333 may further process (e.g., convert to analog, amplify, filter, and upconvert) the output sample stream to obtain a DL signal. In one example, DL signals from modulator/demodulators 1332 and 1333 may be transmitted via the antennas 1334 and 1335, respectively.

The UE 104 may be an example of aspects of the UEs 104 described with reference to FIGS. 1 and 3. At the UE 104, the UE antennas 1352 and 1353 may receive the DL signals from the base station 102 and may provide the received signals to the modulator/demodulators 1354 and 1355, respectively. Each modulator/demodulator 1354 through 1355 may condition (e.g., filter, amplify, downconvert, and digitize) a respective received signal to obtain input samples. Each modulator/demodulator 1354 through 1355 may further process the input samples (e.g., for OFDM, etc.) to obtain received symbols. A MIMO detector 1356 may obtain received symbols from the modulator/demodulators 1354 and 1355, perform MIMO detection on the received symbols, if applicable, and provide detected symbols. A receive (Rx) processor 1358 may process (e.g., demodulate, deinterleave, and decode) the detected symbols, providing decoded data for the UE 104 to a data output, and provide decoded control information to a processor(s) 1380, or memory/memories 1382.

The processor(s) 1380 may in some cases execute stored instructions to instantiate a UE communicating component 342 (see e.g., FIGS. 1 and 3).

On the uplink (UL), at the UE 104, a transmit processor 1364 may receive and process data from a data source. The transmit processor 1364 may also generate reference symbols for a reference signal. The symbols from the transmit processor 1364 may be precoded by a transmit MIMO processor 1366 if applicable, further processed by the modulator/demodulators 1354 and 1355 (e.g., for single carrier-FDMA, etc.), and be transmitted to the base station 102 in accordance with the communication parameters received from the base station 102. At the base station 102, the UL signals from the UE 104 may be received by the antennas 1334 and 1335, processed by the modulator/demodulators 1332 and 1333, detected by a MIMO detector 1336 if applicable, and further processed by a receive processor 1338. The receive processor 1338 may provide decoded data to a data output and to the processor(s) 1340 or memory/memories 1342.

The processor(s) 1340 may in some cases execute stored instructions to instantiate a BS communicating component 442 (see e.g., FIGS. 1 and 4).

The components of the UE 104 may, individually or collectively, be implemented with one or more ASICs adapted to perform some or all of the applicable functions in hardware. Each of the noted modules may be a means for performing one or more functions related to operation of the MIMO communication system 1300. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 1300.

The following aspects are illustrative only and aspects thereof may be combined with aspects of other embodiments or teaching described herein, without limitation.

Aspect 1 a method for wireless communication at a UE that includes receiving, from a network node, an indication of whether paging messages in at least one of multiple paging occasions of a DRX cycle are broadcasted in all of a set of multiple beams or in a portion of the set of multiple beams that does not include all beams in the set of multiple beams, and receiving, based on the indication, one or more paging messages in the at least one of multiple paging occasions of the DRX cycle.

In Aspect 2, the method of Aspect 1 includes where the indication is an indication of paging priority for the UE.

In Aspect 3, the method of Aspect 2 includes determining, based on the indication of paging priority, the multiple paging occasions over which to receive paging messages to include at least one paging occasion over which paging messages are transmitted using at least one of a subset of configured beams corresponding to the UE and a portion of the subset of configured beams configured for the at least one paging occasion and at least one paging occasion over which paging messages are transmitted using the portion of the set of multiple beams including a beam corresponding to the UE.

In Aspect 4, the method of any of Aspects 2 or 3 includes where receiving the indication of paging priority includes receiving the indication of paging priority in NAS, RRC, or UP signaling.

In Aspect 5, the method of any of Aspects 2 to 4 includes where receiving the indication of paging priority includes receiving the indication of paging priority in system information from the network node.

In Aspect 6, the method of any of Aspects 1 to 5 includes where the indication is a flag indicating whether paging signals are transmitted using all of the set of multiple beams in at least one of the multiple paging occasions of the DRX cycle.

In Aspect 7, the method of Aspect 6 includes where the flag indicates that paging signals are transmitted using all of the set of multiple beams in at least one of the multiple paging occasions for a next number of DRX cycles including the DRX cycle.

In Aspect 8, the method of Aspect 7 includes receiving, from the network node, an indication of the next number of DRX cycles.

In Aspect 9, the method of any of Aspects 6 to 8 includes where receiving the flag includes receiving a PEI including the flag.

In Aspect 10, the method of any of Aspects 1 to 9 includes where receiving the indication includes receiving a LP-WUS.

In Aspect 11, the method of Aspect 10 includes where the LP-WUS includes the indication as a parameter.

Aspect 12 is a method for wireless communication at a network node including transmitting, using a subset of configured beams, one or more first paging messages in a first paging occasion of multiple paging occasions of a DRX cycle, and transmitting, for a UE having a paging priority that achieves a threshold, and using at least one of the subset of configured beams that is associated with the UE, one or more second paging messages in a second paging occasion of the multiple paging occasions of the DRX cycle.

In Aspect 13, the method of Aspect 12 includes where the paging priority corresponds to one or more of a type of the UE, or a QoS or a data type related to the one or more second paging messages for the UE.

In Aspect 14, the method of any of Aspects 12 or 13 includes where transmitting the one or more second paging messages includes transmitting, based on the UE associated with the one or more second paging messages having the paging priority that achieves the threshold, the one or more second paging messages in the second paging occasion using the at least one of the subset of configured beams and a portion of the subset of configured beams configured for the second paging occasion.

In Aspect 15, the method of Aspect 14 includes transmitting, for the UE, an indication of the paging priority for the UE.

In Aspect 16, the method of Aspect 15 includes where transmitting the indication of paging priority includes transmitting the indication of paging priority in NAS, RRC, or UP signaling.

In Aspect 17, the method of any of Aspects 15 or 16 includes where transmitting the indication of paging priority includes transmitting the indication of paging priority in system information.

In Aspect 18, the method of any of Aspects 12 to 17 includes transmitting, for the UE, a flag indicating whether paging signals are transmitted using all configured beams in at least one of the multiple paging occasions of the DRX cycle.

In Aspect 19, the method of any of Aspects 17 or 18 includes where the flag indicates that paging signals are transmitted using all configured beams in at least one of the multiple paging occasions for a next number of DRX cycles including the DRX cycle.

In Aspect 20, the method of Aspect 19 includes transmitting, for the UE, an indication of the next number of DRX cycles.

In Aspect 21, the method of Aspect 20 includes where transmitting the indication of the next number of DRX cycles is based on a number of received high priority paging requests.

In Aspect 22, the method of any of Aspects 20 or 21 includes where the indication of the next number of DRX cycles is specific to a cell, one of the configured beams, a time period, or a location.

In Aspect 23, the method of any of Aspects 20 to 22 includes transmitting the indication of the next number of DRX cycles to another network node.

In Aspect 24, the method of any of Aspects 18 to 23 includes where transmitting the flag includes transmitting a PEI including the flag.

In Aspect 25, the method of Aspect 24 includes where transmitting the PEI includes transmitting the PEI using all configured beams.

In Aspect 26, the method of any of Aspects 12 to 25 includes where the paging priority is based on a paging attempt count or an intended number of paging attempts for the UE.

In Aspect 27, the method of Aspect 26 includes receiving, from an upstream node, an indication of the paging attempt count or the intended number of paging attempts for the UE.

In Aspect 28, the method of Aspect 27 includes where the indication is specific to the UE, a cell, or one of the configured beams.

In Aspect 29, the method of any of Aspects 12 to 28 includes receiving, from an upstream node, an indication of the threshold or to support the paging priority for transmitting paging messages.

In Aspect 30, the method of Aspect 29 includes where the indication indicates for which of the configured beams the threshold applies or for which of the configured beams to support the paging priority.

In Aspect 31, the method of any of Aspects 12 to 30 includes transmitting, to another network node, an indication of the threshold, a paging attempt count or an intended number of paging attempts, or a number of DRX cycles during which to transmit paging messages in at least one paging occasion using all configured beams.

In Aspect 32, the method of any of Aspects 12 to 31 includes transmitting, for the UE, a LP-WUS indicating whether paging signals are transmitted using all configured beams in at least one of the multiple paging occasions of the DRX cycle.

In Aspect 33, the method of Aspect 32 includes where transmitting the LP-WUS includes transmitting the LP-WUS using all configured beams based on receiving the one or more second paging messages as a high priority paging message from an upstream network node.

In Aspect 34, the method of any of Aspects 32 or 33 includes where transmitting the LP-WUS includes transmitting the LP-WUS using at least one of the configured beams associated with a high density beam direction and based on receiving the one or more second paging messages as a low priority paging message from an upstream network node.

In Aspect 35, the method of any of Aspects 32 to 34 includes where the LP-WUS includes the indication as a parameter.

In Aspect 36, the method of any of Aspects 12 to 35 includes transmitting, to another network node and based on receiving a response from a second UE to the one or more first paging messages, an indication to refrain from transmitting the one or more second paging messages in the second paging occasion of the DRX cycle.

Aspect 37 is an apparatus for wireless communication including one or more processors, one or more memories coupled with the one or more processors, and instructions stored in the one or more memories and operable, when executed by the one or more processors, to cause the apparatus to perform any of the methods of Aspects 1 to 36.

Aspect 38 is an apparatus for wireless communication including means for performing any of the methods of Aspects 1 to 36.

Aspect 39 is one or more computer-readable media including code executable by one or more processors for wireless communications, the code including code for performing any of the methods of Aspects 1 to 36.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
receive, from a network node, an indication of whether paging messages in at least one of multiple paging occasions of a discontinuous receive (DRX) cycle are broadcasted in all of a set of multiple beams or in a portion of the set of multiple beams that does not include all beams in the set of multiple beams; and
receive, based on the indication, one or more paging messages in the at least one of multiple paging occasions of the DRX cycle.

2. The apparatus of claim 1, wherein the indication is an indication of paging priority for the apparatus.

3. The apparatus of claim 2, wherein the one or more processors are, individually or in combination, configured to execute the instructions to cause the apparatus to determine, based on the indication of paging priority, the multiple paging occasions over which to receive paging messages to include at least one paging occasion over which paging messages are transmitted using at least one of a subset of configured beams corresponding to the apparatus and a portion of the subset of configured beams configured for the at least one paging occasion and at least one paging occasion over which paging messages are transmitted using the portion of the set of multiple beams including a beam corresponding to the apparatus.

4. The apparatus of claim 2, wherein the one or more processors are, individually or in combination, configured to execute the instructions to cause the apparatus to receive the indication of paging priority in non-access stratum (NAS), radio resource control (RRC), or user plane (UP) signaling.

5. The apparatus of claim 2, wherein the one or more processors are, individually or in combination, configured to execute the instructions to cause the apparatus to receive the indication of paging priority in system information from the network node.

6. The apparatus of claim 1, wherein the indication is a flag indicating whether paging signals are transmitted using all of the set of multiple beams in at least one of the multiple paging occasions of the DRX cycle.

7. The apparatus of claim 6, wherein the flag indicates that paging signals are transmitted using all of the set of multiple beams in at least one of the multiple paging occasions for a next number of DRX cycles including the DRX cycle.

8. The apparatus of claim 7, wherein the one or more processors are, individually or in combination, configured to execute the instructions to cause the apparatus to receive, from the network node, an indication of the next number of DRX cycles.

9. The apparatus of claim 6, wherein the one or more processors are, individually or in combination, configured to execute the instructions to cause the apparatus to receive a paging early indication (PEI) including the flag.

10. The apparatus of claim 1, wherein the one or more processors are, individually or in combination, configured to execute the instructions to cause the apparatus to receive the indication including receiving a low-power wakeup signal (LP-WUS).

11. The apparatus of claim 10, wherein the LP-WUS includes the indication as a parameter.

12. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
transmit, using a subset of configured beams, one or more first paging messages in a first paging occasion of multiple paging occasions of a discontinuous receive (DRX) cycle; and
transmit, for a user equipment (UE) having a paging priority that achieves a threshold, and using at least one of the subset of configured beams that is associated with the UE, one or more second paging messages in a second paging occasion of the multiple paging occasions of the DRX cycle.

13. The apparatus of claim 12, wherein the paging priority corresponds to one or more of a type of the UE, or a quality-of-service (QoS) or a data type related to the one or more second paging messages for the UE.

14. The apparatus of claim 12, wherein the one or more processors are, individually or in combination, configured to execute the instructions to cause the apparatus to transmit the one or more second paging messages based on the UE associated with the one or more second paging messages having the paging priority that achieves the threshold, and using the at least one of the subset of configured beams and a portion of the subset of configured beams configured for the second paging occasion.

15. The apparatus of claim 14, wherein the one or more processors are, individually or in combination, configured to execute the instructions to cause the apparatus to transmit, for the UE, an indication of the paging priority for the UE.

16. The apparatus of claim 12, wherein the one or more processors are, individually or in combination, configured to execute the instructions to cause the apparatus to transmit, for the UE, a flag indicating whether paging signals are transmitted using all configured beams in at least one of the multiple paging occasions of the DRX cycle.

17. The apparatus of claim 16, wherein the flag indicates that paging signals are transmitted using all configured beams in at least one of the multiple paging occasions for a next number of DRX cycles including the DRX cycle.

18. The apparatus of claim 17, wherein the one or more processors are, individually or in combination, configured to execute the instructions to cause the apparatus to transmit, for the UE, an indication of the next number of DRX cycles.

19. The apparatus of claim 18, wherein the one or more processors are, individually or in combination, configured to execute the instructions to cause the apparatus to transmit the indication of the next number of DRX cycles based on a number of received high priority paging requests.

20. The apparatus of claim 18, wherein the one or more processors are, individually or in combination, configured to execute the instructions to cause the apparatus to transmit the indication of the next number of DRX cycles to another network node.

21. The apparatus of claim 16, wherein the one or more processors are, individually or in combination, configured to execute the instructions to cause the apparatus to transmit a paging early indication (PEI) including the flag.

22. The apparatus of claim 12, wherein the paging priority is based on a paging attempt count or an intended number of paging attempts for the UE.

23. The apparatus of claim 12, wherein the one or more processors are, individually or in combination, configured to execute the instructions to cause the apparatus to receive, from an upstream node, an indication of the threshold or to support the paging priority for transmitting paging messages.

24. The apparatus of claim 12, wherein the one or more processors are, individually or in combination, configured to execute the instructions to cause the apparatus to transmit, to another network node, an indication of the threshold, a paging attempt count or an intended number of paging attempts, or a number of DRX cycles during which to transmit paging messages in at least one paging occasion using all configured beams.

25. The apparatus of claim 12, wherein the one or more processors are, individually or in combination, configured to execute the instructions to cause the apparatus to transmit, for the UE, a low-power wakeup signal (LP-WUS) indicating whether paging signals are transmitted using all configured beams in at least one of the multiple paging occasions of the DRX cycle.

26. The apparatus of claim 12, wherein the one or more processors are, individually or in combination, configured to execute the instructions to cause the apparatus to transmit, to another network node and based on receiving a response from a second UE to the one or more first paging messages, an indication to refrain from transmitting the one or more second paging messages in the second paging occasion of the DRX cycle.

27. A method for wireless communication at a user equipment (UE), comprising:
receiving, from a network node, an indication of whether paging messages in at least one of multiple paging occasions of a discontinuous receive (DRX) cycle are broadcasted in all of a set of multiple beams or in a portion of the set of multiple beams that does not include all beams in the set of multiple beams; and
receiving, based on the indication, one or more paging messages in the at least one of multiple paging occasions of the DRX cycle.

28. The method of claim 27, wherein the indication is an indication of paging priority for the UE.

29. A method for wireless communication at a network node, comprising:
transmitting, using a subset of configured beams, one or more first paging messages in a first paging occasion of multiple paging occasions of a discontinuous receive (DRX) cycle; and
transmitting, for a user equipment (UE) having a paging priority that achieves a threshold, and using at least one of the subset of configured beams that is associated with the UE, one or more second paging messages in a second paging occasion of the multiple paging occasions of the DRX cycle.

30. The method of claim 29, wherein the paging priority corresponds to one or more of a type of the UE, or a quality-of-service (QoS) or a data type related to the one or more second paging messages for the UE.
